(19) United States
(12) Patent Application Publication
(10) Pub. No.: US 2023/0192359 A1
(43) Pub. Date: Jun. 22, 2023

(54) COLLAPSIBLE CONTAINER SYSTEM AND METHOD OF USE

(71) Applicants: Ronald D. Schieder, Williamsville, KY (US); Jeffrey D. Schieder, Akron, NY (US); Timothy J Schieder, Cherry Hill, NJ (US); Daniel J. Schieder, Cherry Hill, NJ (US)

(72) Inventors: Ronald D. Schieder, Williamsville, KY (US); Jeffrey D. Schieder, Akron, NY (US); Timothy J Schieder, Cherry Hill, NJ (US); Daniel J. Schieder, Cherry Hill, NJ (US)

(21) Appl. No.: 18/084,233

(22) Filed: Dec. 19, 2022

Related U.S. Application Data
(60) Provisional application No. 63/271,200, filed on Dec. 20, 2021.
(60) Provisional application No. 63/271,204, filed on Dec. 20, 2021.

(51) Int. Cl. B65D 21/08

(52) U.S. Cl. CPC B65D 21/086; B65F 2220/1063; A01G 9/026

(57) ABSTRACT

A collapsible container which can be used for a number of purposes. The container can be deployed as a fire pit, as a trash bin, as a planter, or for many other purposes generally suited to containers. The primary function of the invention is to be selectively deployable and collapsible such that it can be taken inside to avoid inclement weather and general deterioration from being stored outdoors. The container is formed from several interlocking pieces or “petals” which fan out from a stored orientation into a deployed orientation forming a container having a container wall surrounding a container base. A central plate can be placed atop the container base to further secure the container in the deployed orientation.

### CROSS-REFERENCE TO RELATED APPLICATION

This application claims priority in U.S. Provisional Patent Application Nos. 63/271,200 and 63/271,204, both filed on Dec. 20, 2021, and which are incorporated herein by reference.

### BACKGROUND OF THE INVENTION

### 1. Field of the Invention

The present invention relates generally to a collapsible container and method for use thereof, and more specifically to a container made of several “petals” which can be selectively deployed or collapsed, where the container is capable of functioning as a fire pit, a trash receptacle, a planter, or other container as needed.

### 2. Description of the Related Art

Temporary and deployable containers for various purposes are well known and understood; however, the function of these containers are usually singular in purpose and rarely would allow for a device to function as a fire pit and a storage container.

Fire pit containers are used to protect the surrounding area from catching on fire while a fire burns inside the fire pit surrounding. This allows the fire to be contained and not spread into unwanted areas. Fire pit receptacles are used for home entertainment, cooking, camping, and heating purposes.

Fire pit containers are traditionally sizeable and bulky not allowing them to be easily stored or transported. They are also designed to be kept outdoors and exposed to the elements that will breakdown and deteriorate the pit container after sometime.

Similarly, extra trash containers are typically used for parties or entertainment and large outdoor flower pots are typically seasonal in many locations, and require a large amount of storage space while not in use. They are also designed to be kept outdoors and exposed to the elements that will breakdown and deteriorate the surrounding after sometime.

Heretofore there has not been available a system or method for a collapsible container with the advantages and features of the present invention.

### BRIEF SUMMARY OF THE INVENTION

The present invention generally provides for a collapsible container which can be used for a number of purposes. The container can be deployed as a fire pit, as a trash bin, as a planter, or for many other purposes generally suited to containers. The primary function of the invention is to be selectively deployable and collapsible such that it can be taken inside to avoid inclement weather and general deterioration from being stored outdoors.

Traditional fire pits for outdoor entertainment and cooking are sizeable and bulky not allowing them to be easily stored or transported. The present invention can serve as a portable fire pit that can collapse into the size of a standard over the shoulder bag for easy transport. The invention details a collapsible fire pit container that can be assembled and disassembled quickly as well as stored in an area with a small footprint. The design includes a number of interlocking sections (“petals”) that form a complete enclosure with a plate installed in the center. Once fully assembled, the fire pit container is designed to stand independently.

Similarly, outdoor trash containers for outdoor entertainment and outdoor seasonal flower pots are sizeable and bulky not allowing them to be easily stored or transported. The present invention can function as a portable trash container and/or flower pot that can collapse into the size of a standard over the shoulder bag for easy transport.

The container design includes two main components, the interlocking side pieces and the center plate. The side components include sections that are cut and bent to interlock. The interlocking aspect of the design occurs towards the top of the pit using one of a variety of interlocking elements to ensure each petal is connected to the adjacent petals. Each of the adjacent sections interlock as the container wall is formed. An optional bottom center pin may be included to keep the interlocking side pieces together during assembly and disassembly. Once all of the interlocking side pieces are interlocked the center pressure plate can be installed. In one embodiment, the center plate provides an outward force on the interlocking side pieces creating a secure wall enclosure.

Disassembly is conducted by removing the center plate, unlocking one of the interlocking side pieces from its adjacent piece(s), and raising the center pin off the ground allowing for the circle to collapse down to approximately the width of a single side piece, plus the depth of the additional side pieces. Each of the interlocking sections are designed to lay overtop of one another once collapsed and utilize a bottom center pin to keep them together as a single unit.

In an embodiment, the center plate can itself be collapsible, having a seam running down its center such that it can be folded in half for easier storage.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of a preferred embodiment collapsible storage system shown in a first, deployed orientation.

FIG. 2 is a three-dimensional isometric view thereof, wherein the upper portions of the interlocking petal elements are shown in hidden lines.

FIG. 3 is a three-dimensional isometric view of a center plate element thereof.

FIG. 4 is a partially-exploded three-dimensional view of the embodiment of FIG. 1 showing the installation of the center plate element of FIG. 3.

FIG. 5 is a three-dimensional isometric view thereof shown in a second, collapsed orientation.

FIG. 6 is a top plan view of the embodiment of FIG. 1.

FIG. 7 is a top plan view of a single interlocking petal element thereof.

FIG. 8 is a top plan view of the center plate element of FIG. 3.

FIG. 9 is a top plan view of the system of claim 1 including the center plate element installed.

FIG. 10 is a partial sectional view taken about the line of FIG. 9.

FIG. 11 is a top plan view of an embodiment interlocking petal element.

FIG. 12 is a top plan view of two interlocking petal elements thereof.

FIG. 13 is a front elevational view of an interlocking petal element.

FIG. 14 is a rear elevational view thereof.

FIG. 15 is a side elevational view thereof.

FIG. 16 is a three-dimensional isometric view of an alternative embodiment center plate shown in a first, deployed orientation.

FIG. 17 is a three-dimensional isometric view thereof shown in a second, folded orientation.

FIG. 18 is a front elevational view of an alternative embodiment interlocking petal element.

FIG. 19 is a top plan view thereof.

FIG. 20 is a front plan view of two interlocking petal elements thereof.

FIG. 21 is a rear plan view of three alternative embodiment interlocking petal elements.

FIG. 22 is a detailed view taken about the circle of FIG. 21.

FIG. 23 is a side elevational view of the alternative embodiment interlocking petal element thereof showing the installation of a clip element.

FIG. 24 is a side elevational view thereof wherein the clip element is fully installed.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Collapsible Container System 2

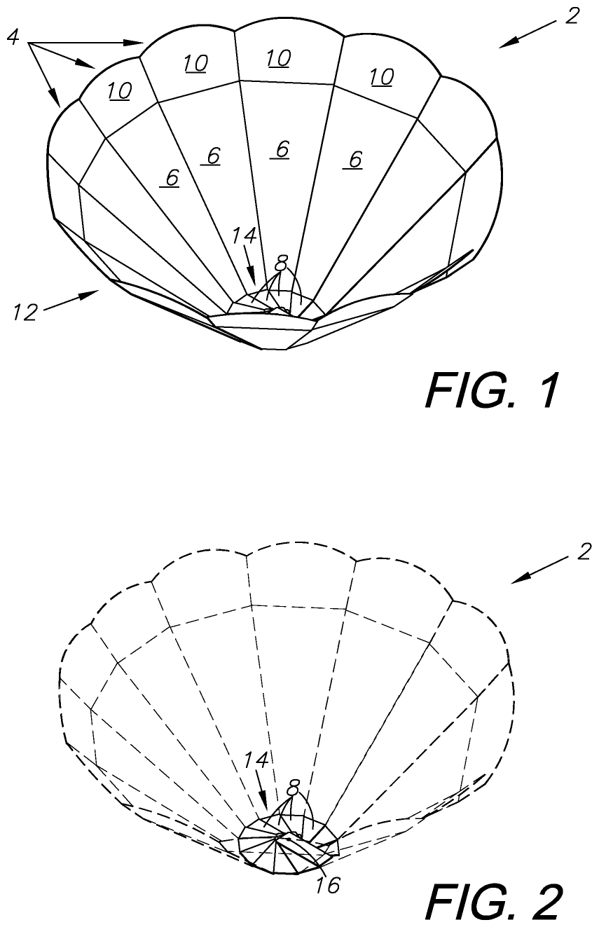

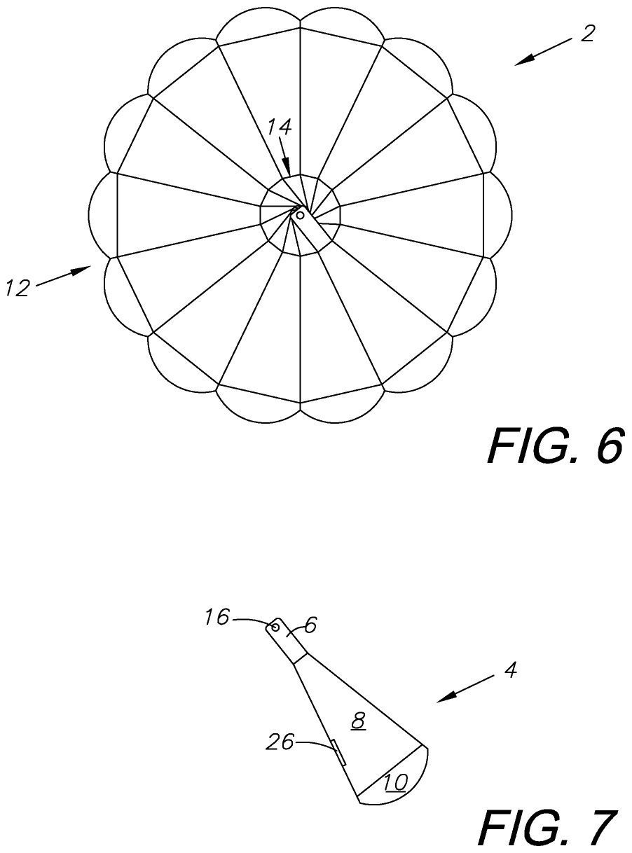

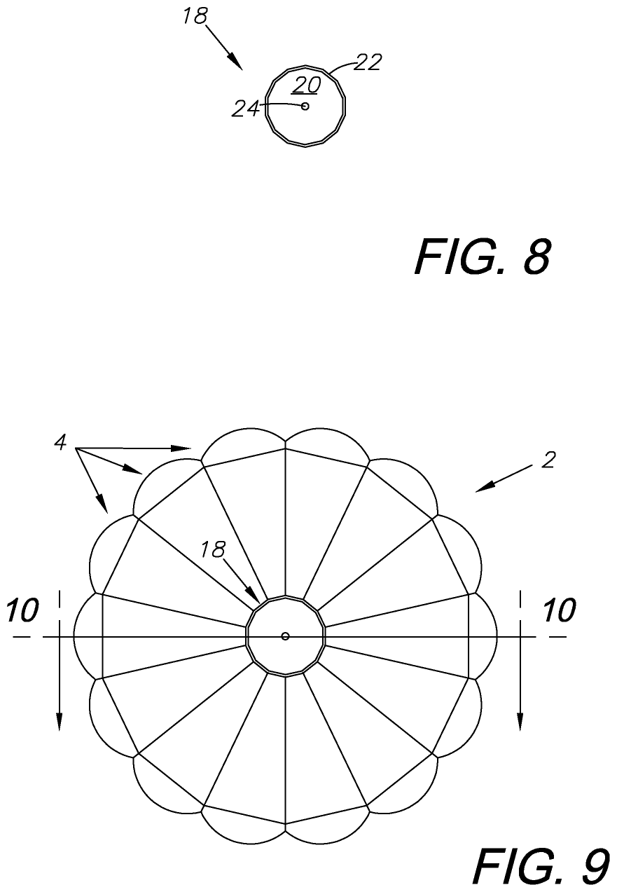

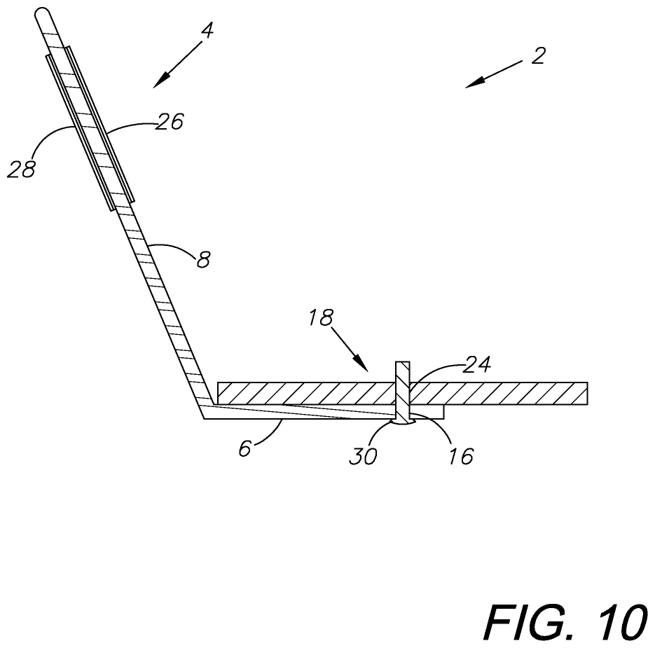

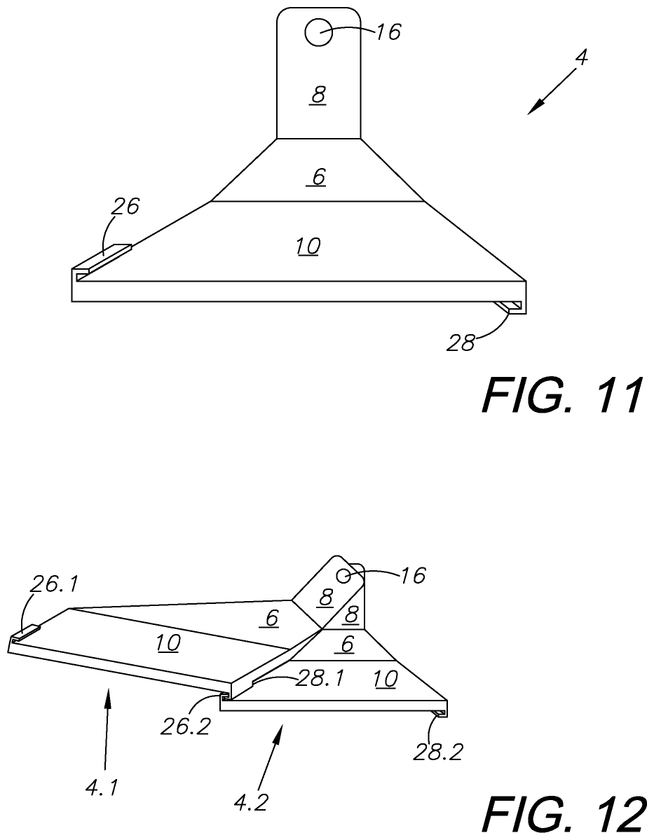

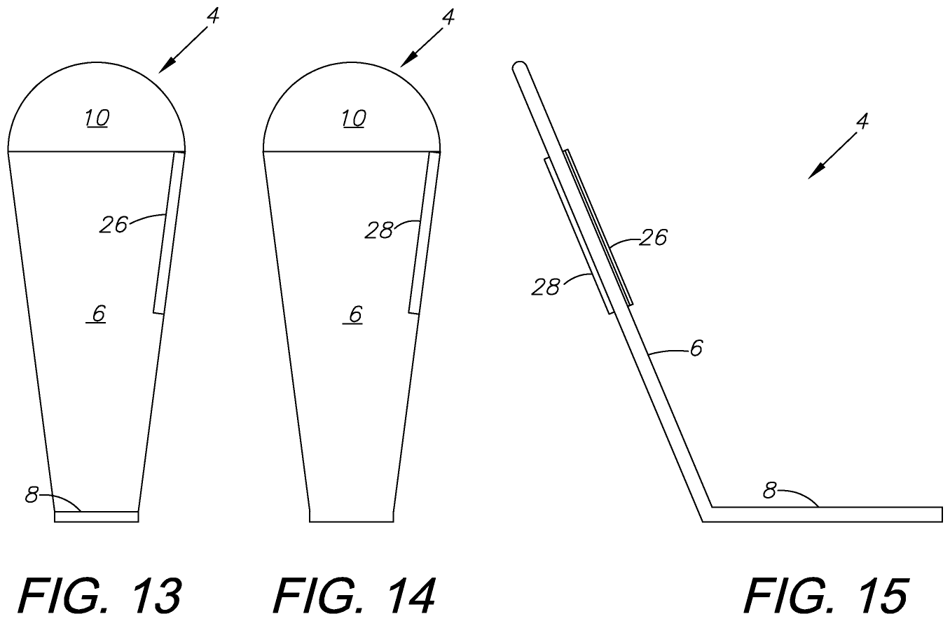

As shown in FIGS. 1-15, an embodiment of the present invention is a collapsible container system 2 which includes several interlocking petal elements 4 which fan out into a first, deployed orientation from a second, collapsed orientation. Each of the petal elements 4 includes at least a base portion 8 and an upper portion 6, wherein the upper portion may include an additional tip portion 10 which may be at an angle from the upper portion 6. The base portion 8 and the upper portion 6 also form a bend of somewhere between 90 degrees and 175 degrees, such that the base portions 8 of the plurality of petals 4 forms a container base 14, while the upper portion 6 and optional tip 10 fan out into a somewhat circular container wall 12. A central pin hole 16 can receive a pin 30 to ensure the individual petals 4 are in their proper orientation.

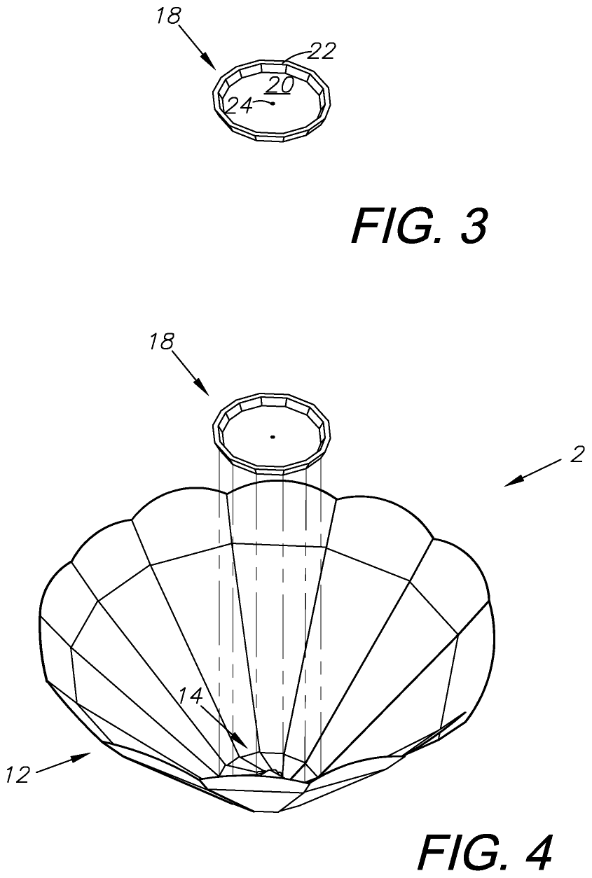

FIG. 3 shows a center plate 18 which has a plate base 20, a plate edge 22, and a center receiver 24 which can also receive the pin 30 when fully assembled. FIG. 4 shows the center plate 18 being inserted onto the container base 14. The plate edge 22 pushes out against the interior face of each respective upper portion 6 of each respective interlocking petal 4, keeping the shape of the container wall 12 locked in place.

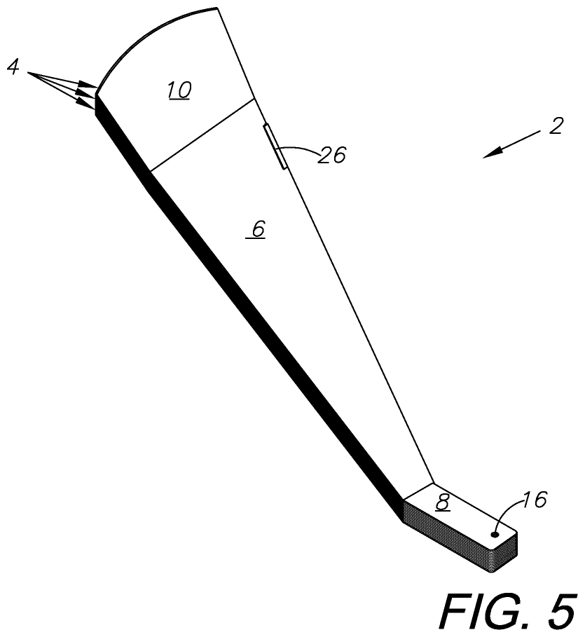

FIG. 5 demonstrates how the individual interlocking petals 4 can pivot around the central pin hole 16 to overlap, thereby becoming the second, collapsed orientation. in this orientation, the entire assembly takes up a much smaller footprint and can be stored in a bag or easily stored within a closet or other storage container.

Each of the interlocking petals 4 has a front connector 26 and a rear connector 28, allowing each interlocking petal to lock with its adjacent petal(s) by locking a petal's rear connector 28 with an adjacent petal's front connector 26. FIG. 12 shows this in detail wherein a first petal 4.1 has a first front connector 26.1 and a first rear connector 26.1, and a second petal 4.2 has a second front connector 26.2 and a second rear connector 28.2. The first rear connector 28.1 of the first petal 4.1 is interlocked with the second front connector 26.2 of the second petal 4.2. This process would continue around the entire container wall. The first petal 4.1 may interlock with the final petal in the chain, or that petal may simply sit adjacent to that final petal as shown in FIG. 1.

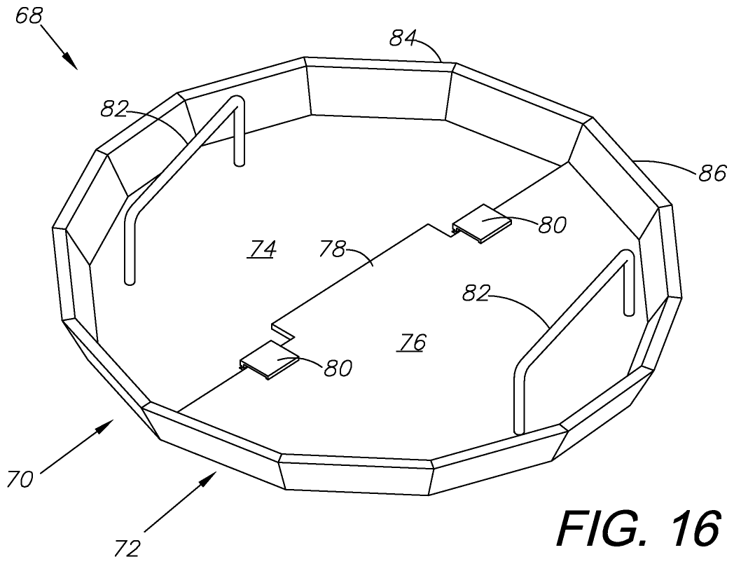

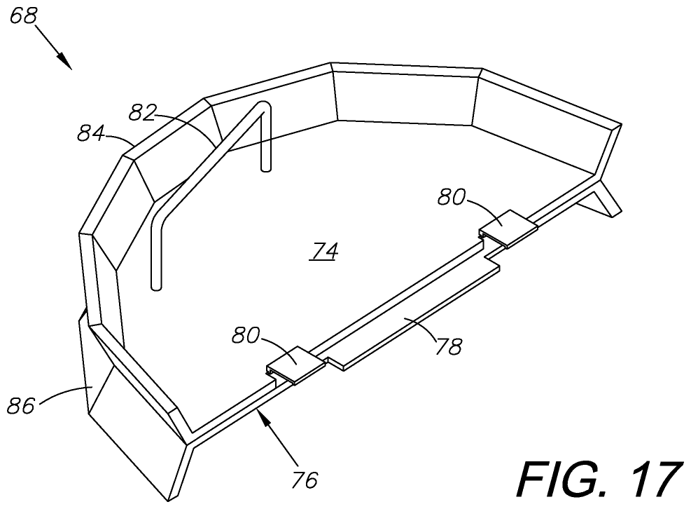

FIG. 16 shows an alternative embodiment center plate 68 which has two halves; a first half 70 and a second half 72. These two halves can hinge about the center of the plate 68. The first half has a first plate base 74 and a first plate edge 84. The second half 72 has a second plate base 76 and a second plate edge 86. Each half may include a handle 82 for lifting the plate 68 out of the container system 2. The first half 70 includes some clips 80 which can be used to lock the second half 72 in place in a first, deployed orientation. The second half 72 also includes a tongue 78 which helps to lock the two halves in place and prevents over-rotation about the hinged center. FIG. 17 shows the same center plate 68 in a second, folded orientation for storage.

### III. Alternative Embodiment Interlocking Petals 104

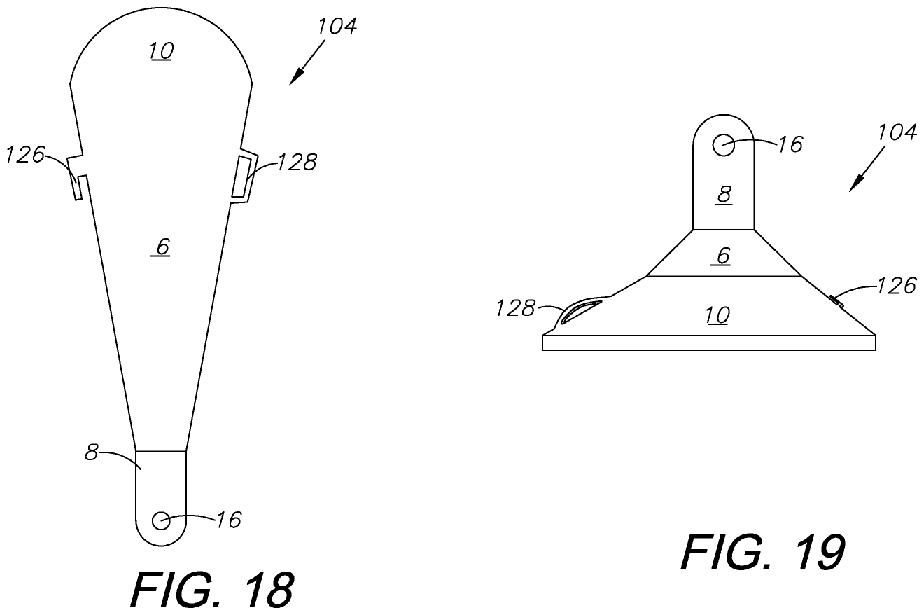

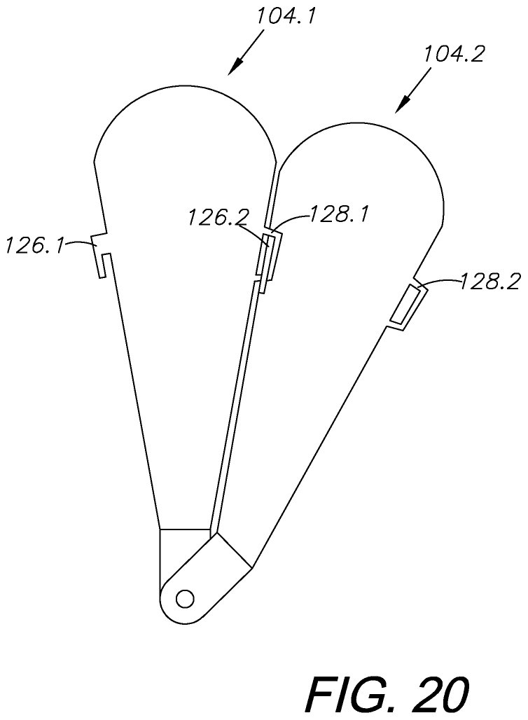

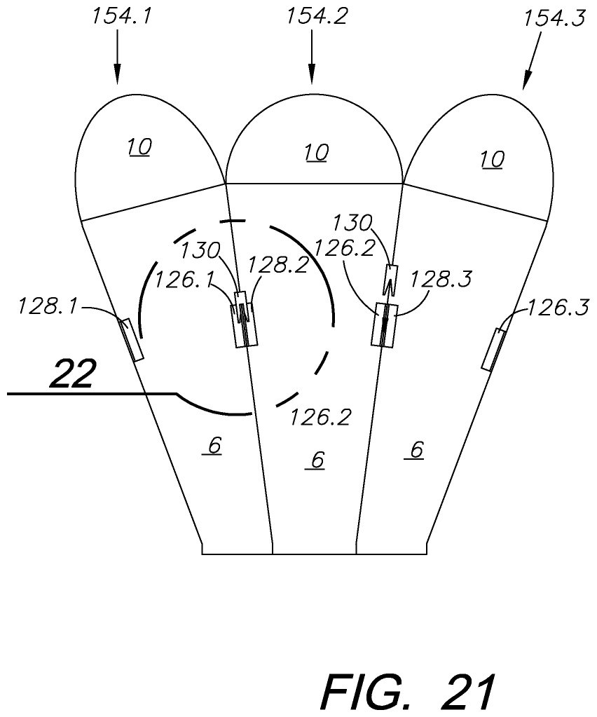

FIGS. 18-20 show an alternative embodiment interlocking petal 104 which can be used in the same manner as the interlocking petals 4 taught in the previous embodiment. Here, each petal includes an insert connector 126 and a receiver connector 128 forming a type of hook and loop connection between adjacent petals. FIG. 20 shows how a first alternative embodiment interlocking petal 104.1 and a second alternative embodiment interlocking petal 104.2 could use these connectors to interlock. The first petal 104.1 has a first insert connector 126.1 and a first receiver connector 128.1. Similarly, the second petal 104.2 has a second insert connector 126.2 and a second receiver connector 128.2. As shown, the second insert connector 126.2 is inserted through the hole of the first receiver connector 128.1. A before, this process would continue around the entire container wall. The first petal 104.1 may interlock with the final petal in the chain, or that petal may simply sit adjacent to that final petal as shown in FIG. 1.

### IV. Alternative Embodiment Interlocking Petals 154

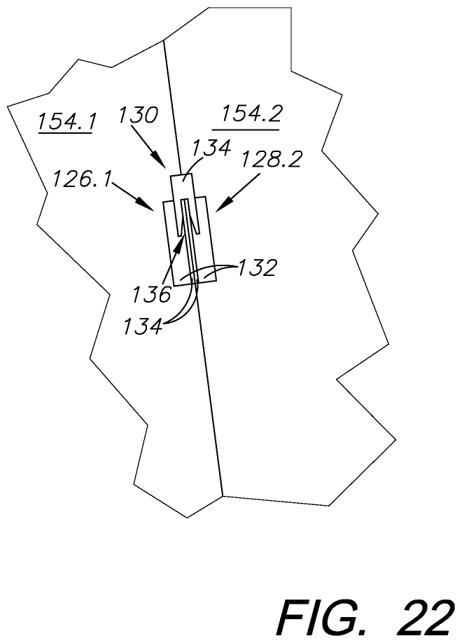

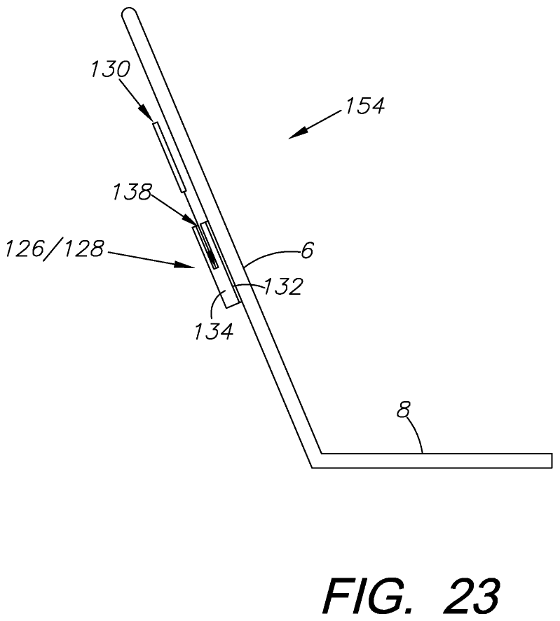

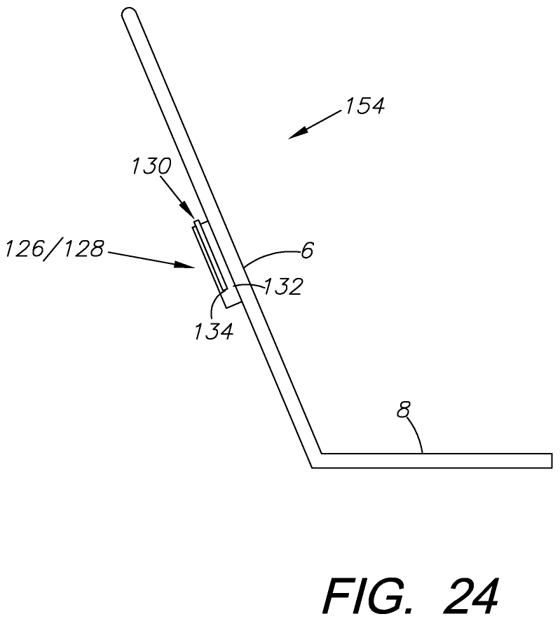

FIGS. 21-24 show another alternative embodiment interlocking petal 154 which can be used in the same manner as the interlocking petals 4 taught in the previous embodiment. FIG. 21 shows three interlocking petals 154; a first interlocking petal 154.1, a second interlocking petal 154.2, and a third interlocking petal 154.3. The first interlocking petal 154.1 has a first left connector 128.1 and a first right connector 126.1; the second interlocking petal 154.2 has a second left connector 128.2 and a second right connector 126.2; and the third interlocking petal 154.3 has a third left connector 128.3 and a third right connector 126.3.

Each pair of left 128 and right 126 connectors that are adjacent can be secured via a clip 130 which slots into a relief 138 within each of the left 128 and right 126 connectors. The clip 130 can also include a notch 136 which allows the clip to further slot into the relief 138 of the connectors 126, 128. The main body 134 of the clip 130 can be gripped to remove the clip as desired. When slotted into the respective left 128 and right 126 connectors, the clip locks the two adjacent interlocking petals 154 together. So referring to FIG. 21 again, the clip 130 being shown slotted between the second right connector 126.2 of the second interlocking petal 154.2 and the third left connector 128.3 of the third interlocking petal 154.3 will secure the two petals together to form the container wall.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A container system comprising:
a container formed from a plurality of interlocking members, each interlocking member comprising a lower portion and an upper portion separated by a bend;
said plurality of interlocking members configured to be transformed from a first, collapsed orientation wherein said plurality of interlocking members form a stack of interlocking members, to a second, deployed orientation wherein said plurality of interlocking members fan out to form a container having an interior space defined by a container wall formed by the upper portions of said plurality of interlocking members and a container base formed by the lower portions of said plurality of interlocking members; and
a central plate configured to be inserted into said interior space and placed adjacent to said container base, said central plate comprising a plate base and a plate edge, wherein said plate edge is configured to press against the upper portions of said plurality of interlocking members, thereby securing the plurality of interlocking members in place.

2. The container system of claim 1, further comprising:
each of said plurality of interlocking members further comprising a first locking element and a second locking element; and
wherein said first locking element of each respective one of said plurality of interlocking members configured to connect to the second locking element of an adjacent one of said plurality of interlocking members, such that each of said plurality of interlocking members is interlocked with at least one adjacent interlocking member.

3. The container system of claim 1, further comprising:
each said first locking element comprising a connector having a hook;
each said second locking element comprising a loop; and
wherein said loop is configured to receive said hook of said adjacent one of said plurality of interlocking members.

4. The container system of claim 2, further comprising:
each said first locking element comprising an L-shaped hook located on a front face of each respective interlocking member;
each said second locking element comprising an L-shaped hook located on a rear face of each respective interlocking member; and
wherein said L-shaped hook located on the front face of the respective one of said plurality of interlocking members is configured to interlock with said L-shaped hook located on the rear face of said adjacent one of said plurality of interlocking members.

5. The container system of claim 2, further comprising:
each said first locking element comprising a connector having a first relief;
each said second locking element comprising a second relief;
a clip having a main body terminating into a notch configured to be received by said first relief and said second relief; and
wherein said first locking element and said second locking element are configured to be placed adjacent to one another such that said clip can securely lock said first locking element to said second locking element via said first and second reliefs.

6. The container system of claim 1, further comprising:
said central plate comprising a first half and a second half joined together at a hinge;
said first half comprising at least one clip for securing said first half to said second half in a first, deployed orientation; and
wherein said central plate is configured to be selectively folded in half about said hinge to form a second, stored orientation.

7. The container system of claim 1, wherein said container is configured to be used as a storage container selected from the list comprising: a fire pit; a trash can; and a planter.

8. A method of deploying a container, the method comprising the steps:
providing a container comprising a plurality of interlocking members arranged in a first, stored orientation whereby each of said plurality of interlocking members form a stack of interlocking members, each of said plurality of interlocking members comprising a lower portion and an upper portion separated by a bend, whereby each of said plurality of interlocking members are joined about a pivot pin passing through each respective lower portion of each of said plurality of interlocking members,
fanning said plurality of interlocking members out, such that said plurality of interlocking members pivot about said pivot pin to form a container wall with each said upper portion and a container base with each said lower portion, thereby transforming said container into a second, deployed orientation;
placing a center plate within said container adjacent to said container base, said center plate comprising a plate base and a plate edge; and
securing said container wall by pressing outwardly against said upper portions of said plurality of interlocking members with said plate edge.

9. The method of claim 8, further comprising the steps
providing each of said plurality of interlocking members a first locking element and a second locking element; and
interlocking said first locking element of each respective one of said plurality of interlocking members with said second locking element of an adjacent one of said plurality of interlocking members.

10. The method of claim 9, wherein:
each said first locking element comprising a connector having a hook; and
each said second locking element comprising a loop; and
wherein said loop is configured to receive said hook of said adjacent one of said plurality of interlocking members.

11. The method of claim 9, wherein:
each said first locking element comprising an L-shaped hook located on a front face of each respective interlocking member;
each said second locking element comprising an L-shaped hook located on a rear face of each respective interlocking member; and
wherein said L-shaped hook located on the front face of the respective one of said plurality of interlocking members is configured to interlock with said L-shaped hook located on the rear face of said adjacent one of said plurality of interlocking members.

12. The method of claim 9, wherein:
each said first locking element comprising a connector having a first relief;
each said second locking element comprising a second relief;
a clip having a main body terminating into a notch configured to be received by said first relief and said second relief; and
wherein said first locking element and said second locking element are configured to be placed adjacent to one another such that said clip can securely lock said first locking element to said second locking element via said first and second reliefs.

13. The method of claim 8, further comprising the steps:
securing a first half of said center plate to a second half of said center plate with at least one clip, thereby forming a first, deployed orientation;
selectively disengaging said at least one clip;
folding said first half and said second half about a hinge joining said first half and said second half; and
forming a second, stored orientation whereby said first half and said second half are folded together.

14. The method of claim 8, wherein said container is configured to be used as a storage container selected from the list comprising: a fire pit; a trash can; and a planter.
